(19) United States
(12) Patent Application Publication
(10) Pub. No.: US 2010/0071836 A1
(43) Pub. Date: Mar. 25, 2010

(54) Sealing of Mica Wnidows for Geiger-Muller Tubes

(76) Inventor: Roy Watson, Concord (CA)

Correspondence Address: CARSTENS & CAHOON, LLP, P O BOX 802334, DALLAS, TX, 75380, US

(21) Appl. No.: 12/557,261

(22) Filed: Sep. 10, 2009

Related U.S. Application Data
(60) Provisional application No. 61/098,638, filed on Sep. 19, 2008.

(51) Int. Cl. B32B 38/00

(52) U.S. Cl. 156/89.12

(57) ABSTRACT

The present invention provides a method for manufacturing radiation detectors such as Geiger-Müller detectors. The method includes pre-forming a frit ring via extrusion or stamping. The preformed frit ring is placed in the aperture of a metal cathode body along with a radiation transparent window made of mica. The window is slightly larger than the perimeter of the aperture, thereby forming an overlap area. The frit ring is placed between the cathode and window within this overlap area. The assembled components are then fired at an appropriate temperature to cause fusion of the frit with the metal cathode and window to form a gas-tight seal.

### CROSS-REFERENCE TO RELATED APPLICATIONS

This application claims the benefit of and priority to U.S. Provisional Patent Application No. 61/098,638 filed Sep. 19, 2008 the technical disclosures of which are hereby incorporated herein by reference.

### TECHNICAL FIELD

The present invention relates to the use of a frit ring in the construction and sealing of the detector window to the detector body of the Geiger Muller (GM) gas-filled radiation detector.

### BACKGROUND OF THE INVENTION

Geiger-Müller (GM) tubes are the sensing components of Geiger counters and are members of the gas-filled radiation detector family that provide easy means to detect and measure ionizing radiation including alpha particles, beta particles, x-rays and gamma rays.

FIG. 1 shows a typical cylindrical GM tube in accordance with the prior art. Typical GM tubes comprise a tube filled with a low pressure inert gas such as helium, neon or argon in the 50-100 torr range.

The GM tube includes electrodes with a large potential difference (up to 1200 volts) but no current. The anode 101 is a wire passing through the center of the tube, and the walls of the tube form the cathode 102. The walls of the tube are usually made of metal or are coated with metal or graphite on the inside.

The GM tube is connected to an external detector circuit, as shown in FIG. 2. Current in this external circuit is dependent on the conductivity of the gas. In the absence of ionization, the inert gas in the tube acts as an insulator.

If ionizing radiation passes through the tube, it will ionize the gas in the tube by “knocking” electrons off some of the molecules, thereby producing positive ions (cations) and free electrons. The potential difference between the anode and cathode accelerates the ions toward the cathode and the electrons toward the anode. As the electrons accelerate toward the anode, they gain sufficient kinetic energy to ionize other gas molecules through collision, creating secondary ion pairs. The electrons released from this secondary ionization in turn collide with and ionize other gas molecules, producing a cascade of ionization known as a Townsend avalanche.

The ionization of the gas produces a current pulse in the external circuit which is fed to a counter 201, hence the familiar name Geiger counter. Most GM detectors also include an audio amplifier (not shown) that produces an audible click upon discharge.

FIG. 3 is a graph illustrating different regions of voltage potential used with gas-filled radiation detectors. The voltage range used in GM tubes is known as the Geiger-Müller plateau. At the Geiger-Müller plateau the potential difference is strong enough to produce a complete Townsend avalanche and ionize virtually all of the gas inside the tube upon triggering by radiation, such that the size of the pulse is the same regardless of the energy of the radiation that triggered the pulse. This essentially makes detectors operating at the Geiger-Müller plateau binary in operation. Voltages below this plateau are not strong enough to cause complete discharge, and voltages above the plateau produce self-sustaining discharges that continue as long as voltage is applied and can be damaging to the detector. The specific voltage for a Geiger-Müller plateau will vary depending on the characteristics of the specific counter (e.g., size, gas type, etc.). Reducing the gas pressure in the tube lowers the strength of the electric field necessary to reach the Geiger-Müller region.

After the discharge pulse produce by the ionization avalanche, it is important that the gas de-ionize quickly and return to a neutral state. The GM tube must produce only a single pulse (count) upon entry of a single ionizing particle (alpha, beta) or energy quantum (x-ray, gamma ray).

The ions produced by the radiation and avalanche become neutral by gaining electrons when they collide with the cathode. However, the energy of the collision may cause the emission of secondary electrons that can cause ionization of other gas molecules, resulting in another avalanche that produces a false discharge. To avoid such false discharges and ensure that the GM tube only produces one pulse for each particle that enters the tube, a quenching gas is included in the tube along with the inert gas.

The quenching gas is typically a halogen such as bromine or chlorine. The quenching gas has an ionization potential that is lower than that of the main (noble) detection gas in the tube. As the ions of the main gas move toward the cathode they collide with the quencher gas molecules and “steal” electrons from these molecules, thereby becoming neutral. The resulting quencher gas ions contact the cathode and return to neutral by gaining electrons from the cathode. However, unlike the main gas ions, the quencher gas ions do not have sufficient energy to cause emission of secondary electrons.

FIG. 4 shows a GM detector that has a flat or “pancake” shape in accordance with the prior art. The operation of the pancake GM detector is the same as that described above for the cylindrical configuration. The pancake GM tube is essentially a truncated cylinder. The anode 401 used in the pancake shape is circular in a plane parallel to the face of the pancake. The outer case 402 of the pancake forms the cathode.

Both cylindrical and pancake GM tubes include a window, which is located at one end 103 of cylindrical GM tubes and forms one of the faces 403 of pancake GM tubes. The window is made of radiation-transparent material that allows ionizing radiation to enter the tube. Typically windows are made of glass or mica. Glass has the advantage of being less expensive than mica but unlike mica does not allow alpha particles to penetrate. Therefore, mica is the preferred choice in most GM tube designs.

In the construction method of the prior art, the mica end window is typically sealed in place to the cathode body by first mixing a slurry of “frit” (ground glass or glaze), “painting” a thin layer of the wet frit around the perimeter of the window and cathode interface, and then firing (baking) at suitable temperature to cause fusion between the frit and the cathode metal body, thereby forming a seal that is impermeable to gas leakage.

Manually premixing and painting of the frit makes this manufacture method very time consuming and labor intensive. Therefore, it would be desirable to have a manufacture method for Geiger-Müller tubes that reduces time and labor while improving the quality of the seal to prevent slow leaks and providing a reproducible process that is amenable to semi-automation or full automation to increase productivity.

### SUMMARY OF THE INVENTION

The present invention provides a method for manufacturing radiation detectors such as Geiger-Müller (GM) detectors. To the avoid the time and labor costs of manually mixing and painting frit during the manufacture of GM detectors, the present invention uses preformed frit rings made via extrusion or stamping. The preformed frit ring is placed in the aperture of a metal cathode body along with a radiation transparent window made of mica. The window is slightly larger than the perimeter of the aperture, thereby forming an overlap area. The frit ring is placed between the cathode and window within this overlap area. The assembled components are then fired at an appropriate temperature to cause fusion of the frit with the metal cathode and window to form a gas-tight seal. The frit material has negligible residual binder material after firing as well as negligible metallic impurities after fusion with the cathode and window.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 shows a typical cylindrical Geiger-Müller (GM) tube in accordance with the prior art;

FIG. 2 show an external detector circuit used in connection with a GM tube in accordance with the prior art;

FIG. 3 is a graph illustrating different regions of voltage potential used with gas-filled radiation detectors;

FIG. 4 shows a GM detector that has a flat or “pancake” shape in accordance with the prior art; and

FIG. 5 shows a preformed frit ring for use in a pancake GM detector in accordance with the present invention.

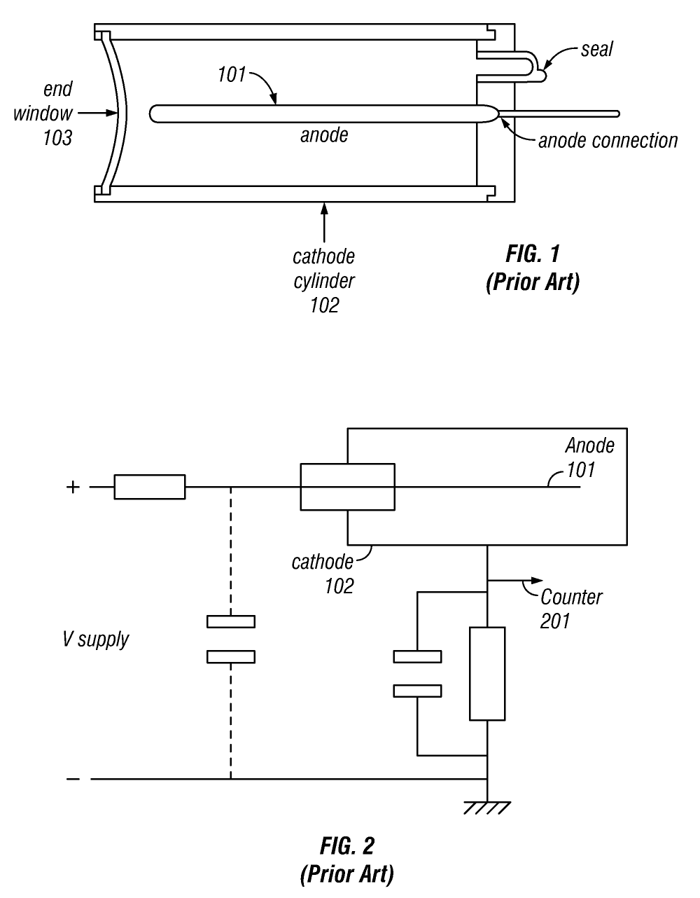

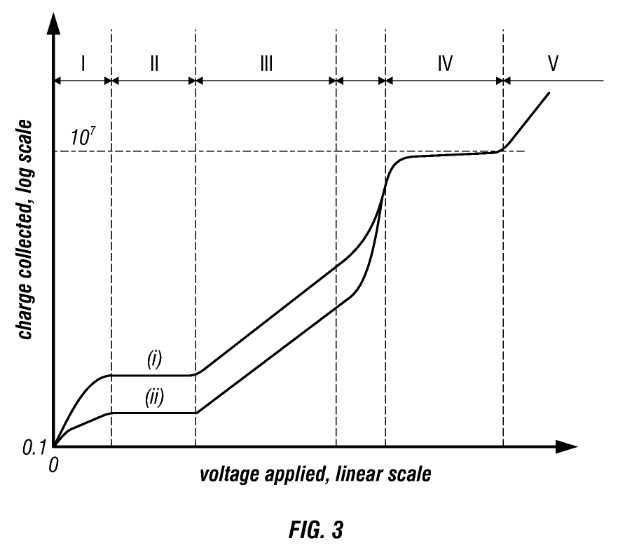

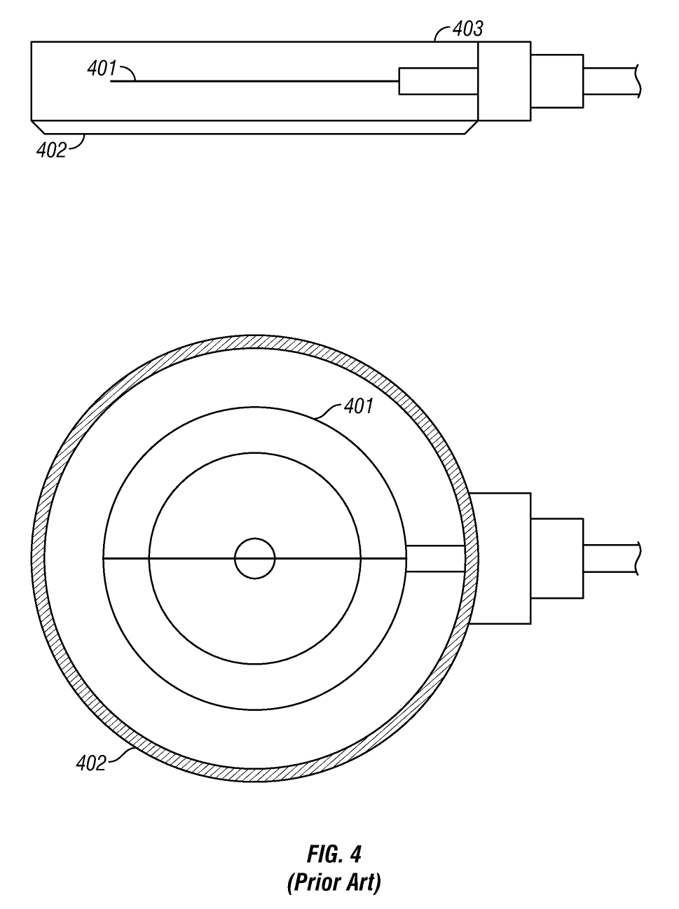

### DETAILED DESCRIPTION

The present invention provides a method for manufacturing a radiation detector that comprises using a preformed frit ring that is used to seal a radiation transparent window to the metal cathode body of a Geiger-Müller (GM) detector.

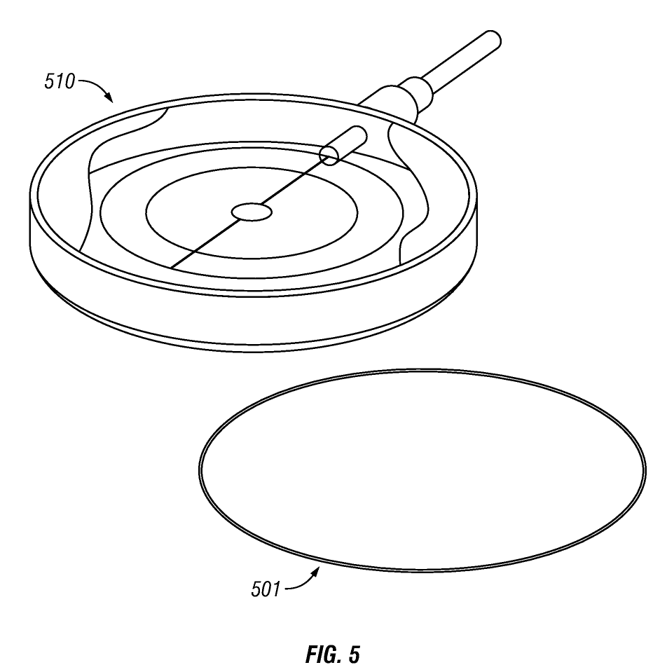

FIG. 5 shows a pre-formed frit ring 501 for use in a pancake GM detector 510 in accordance with the present invention. While the present example uses a pancake GM detector 510, the present invention is equally application to cylindrical GM tubes and is not limited to a circular geometry or a specific size of window. The preformed frit ring 501 can be of various sizes and shapes to match different GM models.

The preformed frit ring 501 is manufactured by extrusion or stamping. The material from which the frit ring is made is selected to have the following properties:
Negligible residual binder material after firing;
Readily fuses to form a gas-tight seal with the metal cathode and mica window;
A thermal coefficient of expansion compatible with the metal cathode (typically stainless steel); and
Negligible metallic impurities after fusion which could introduce contamination to the GM detector.

The preformed frit ring 501 approximates the perimeter of the mica window/cathode body interface. The mica window is slightly larger than the aperture in the cathode body, thereby forming an overlap area. The frit ring is sized to fit within this overlap area. In this manner, instead of having to paint wet frit slurry around the perimeter of the mica window and cathode interface, the pre-formed frit ring is simply placed between window and the aperture of the cathode body then fired to fuse with the window and cathode.

By using a preformed frit ring, the present invention allows for a construction method that results in a consistent, reliable seal that is amenable to a semi-automated or automated GM detector manufacturing process.

The frit ring construction method of the present invention offers significant benefits. The labor time using the preformed ring is typically two minutes for assembly versus 20-30 minutes using the prior art method of “painting” on the frit slurry. Another important benefit is more consistent quality in manufacturing. Because the frit ring is formed by extrusion or stamping rather than manually painted on while wet, each frit ring is essentially identical, thereby eliminating the variation that naturally occurs with manual manufacture. The increased uniformity and efficiency of performing the frit rings via extrusion or stamping also reduces wasteful use of material. The manufacture method of the present invention produces approximately 20% greater output yield from a given input of material.

Another important benefit of the present invention is worker safety. Because the workers assembling the GM tubes do not have to manually mix and paint wet frits there is less handling of the raw materials and no exposure to free air powder, thereby potentially reducing health care costs for the industry in addition to the reduced manufacturing costs.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

I claim:

1. A method for manufacturing a radiation detector, comprising the steps of:
(a) pre-forming a frit ring;
(b) placing the preformed frit ring and a radiation transparent window in an aperture of a metal cathode body, wherein the window is larger than the perimeter of the aperture, thereby creating an overlap area between the window and the cathode body, and wherein the frit ring is positioned between the cathode body and window and is sized to fit within said overlap area; and
(c) firing the assembled cathode body, frit ring and radiation transparent window, causing fusion of the frit with the metal cathode and window to form a gas-tight seal.

2. The method according to claim 1, wherein the frit ring is pre-formed via extrusion.

3. The method according to claim 1, wherein the frit ring is pre-formed via stamping.

4. The method according to claim 1, wherein the frit ring has negligible residual binder material after firing.

5. The method according to claim 1, wherein the frit ring has negligible metallic impurities after fusion with the cathode and window.

6. The method according to claim 1, wherein said radiation transparent window is made of mica.

7. The method according to claim 1, wherein the radiation detector is a Geiger-Müller detector.
